(19) United States
(12) Patent Application Publication
(10) Pub. No.: US 2015/0287488 A1
(43) Pub. Date: Oct. 8, 2015

(54) WASHABLE RADIATION PROTECTIVE WEARING APPAREL

(71) Applicant: Barrier Technologies, LLC, Davie, FL (US)

(72) Inventors: Marc E. GLICKMAN, Davie, FL (US); Richard LAZZARA, Palm Beach, FL (US)

(21) Appl. No.: 14/677,464

(22) Filed: Apr. 2, 2015

Related U.S. Application Data
(60) Provisional application No. 61/974,076, filed on Apr. 2, 2014.

(51) Int. Cl. G21F 3/03

(52) U.S. Cl. CPC G21F 3/03

(57) ABSTRACT

A radiation protective garment (100), which can be washed in conventional washing machine, includes a pliable and flexible radiation protection barrier that can withstand rigors and violent movements associated with machine washing. The garment includes an outer layer (111), a middle layer (112) and an inner layer (113). A binding cloth (114) is sewn onto the garment using a heavy thread (120) to bind the three layers together.

### CROSS-REFERENCE TO RELATED APPLICATIONS

This application is claims priority from U.S. Provisional Patent Application No. 61/974,076, filed on Apr. 2, 2014, with inventors Marc E. Glickman and Richard Lazzara, and commonly assigned herewith to Barrier Technologies, LLC, the entire disclosure of which is incorporated herein by reference in its entirety.

### BACKGROUND

1. Field

This invention relates generally to radiation controlling means and more particularly to articles of wearing apparel to protect a wearer against harmful electromagnetic or nuclear radiation.

2. Related Art

Known radiation protective apparel, or garments, such a type used in medicine and dentistry, cannot be adequately cleaned. The only known method used for cleaning radiation protective garments is by spraying a superficial cleaner on the garment and wiping down the garment. As a result, a same radiation protective apparel may be used many times and/or for many years without adequate cleaning.

Known radiation protective garments cannot be machine washed, i.e., washed in a conventional washing machine used to wash normal clothing, because known radiation protective garments are stiff, and, therefore, creases, tears and/or holes occur in a radioprotective core material within such garments. Such creases, tears and/or holes allow radiation to pass through to a wearer of such a known radiation protective garment. Additionally, stitching of known radiation protective garments does not hold up well to rough treatment that occurs in a washing machine because of rigidity of the radioprotective core material combined with movement during machine washing.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a simplified plan view of a first side of one embodiment of a washable radiation protective wearing apparel in accordance with the invention.

FIG. 2 is a simplified plan view, partially opened, of the first side of the washable radiation protective wearing apparel of FIG. 1.

FIG. 3 is a simplified plan view of a second side, opposite the first side, of the washable radiation protective wearing apparel of FIG. 1.

### DETAILED DESCRIPTION

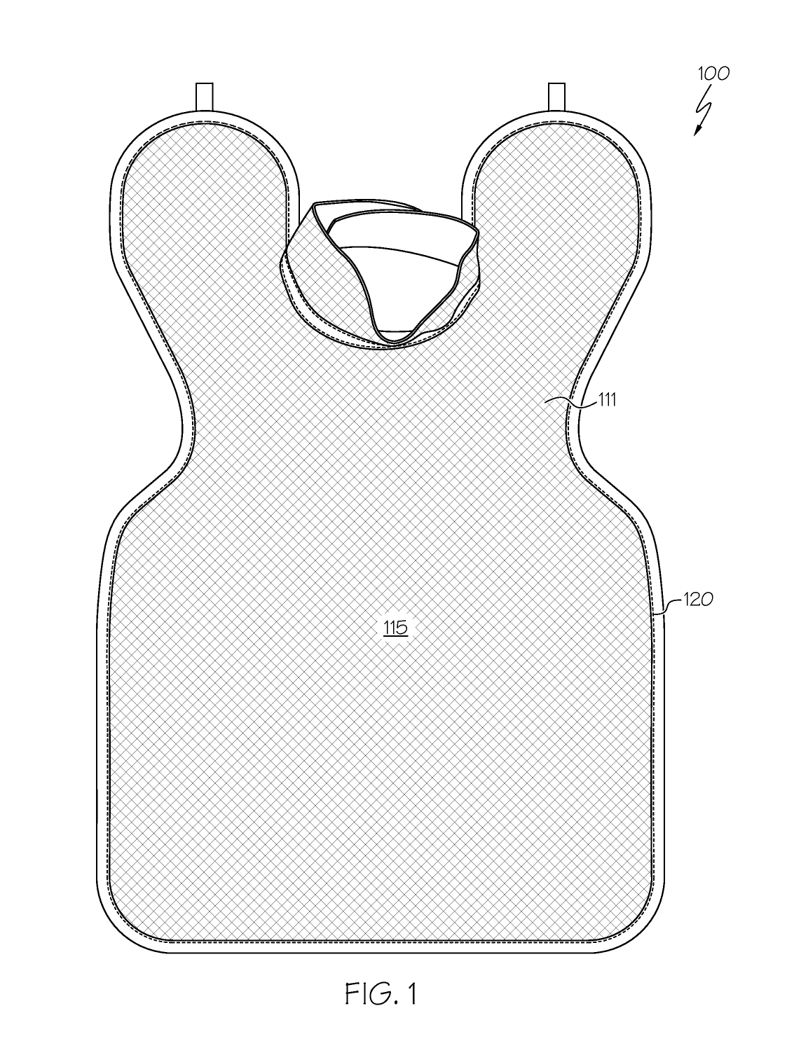

FIG. 1 is a simplified plan view of a first side of one embodiment of a washable radiation protective wearing apparel 100 in accordance with the invention. The washable radiation protective wearing apparel, or garment, 100 in accordance with the invention includes three (3) layers: an outer layer 111, a middle layer 112 and an inner layer 113. The shape of the garment 100 shown in FIGS. 1, 2 and 3, is arbitrary, and has been selected for illustrative purposes only.

The outer layer 111 the garment 100 is shown in FIG. 1. The outer layer 111 is a layer farthest from a wearer when the garment is properly worn. A farthest side 115 of the outer layer 111 is shown in FIG. 1. The outer layer 111 comprises a water repellent or resistant material, such as a ripstop fabric. In one embodiment, the ripstop fabric of the outer layer 111 is a nylon/polydiamond ripstop fabric. In one embodiment, the ripstop fabric of the outer layer 111 is a ripstop fabric from Top Valve Fabrics Inc., of Carmel, Ind.

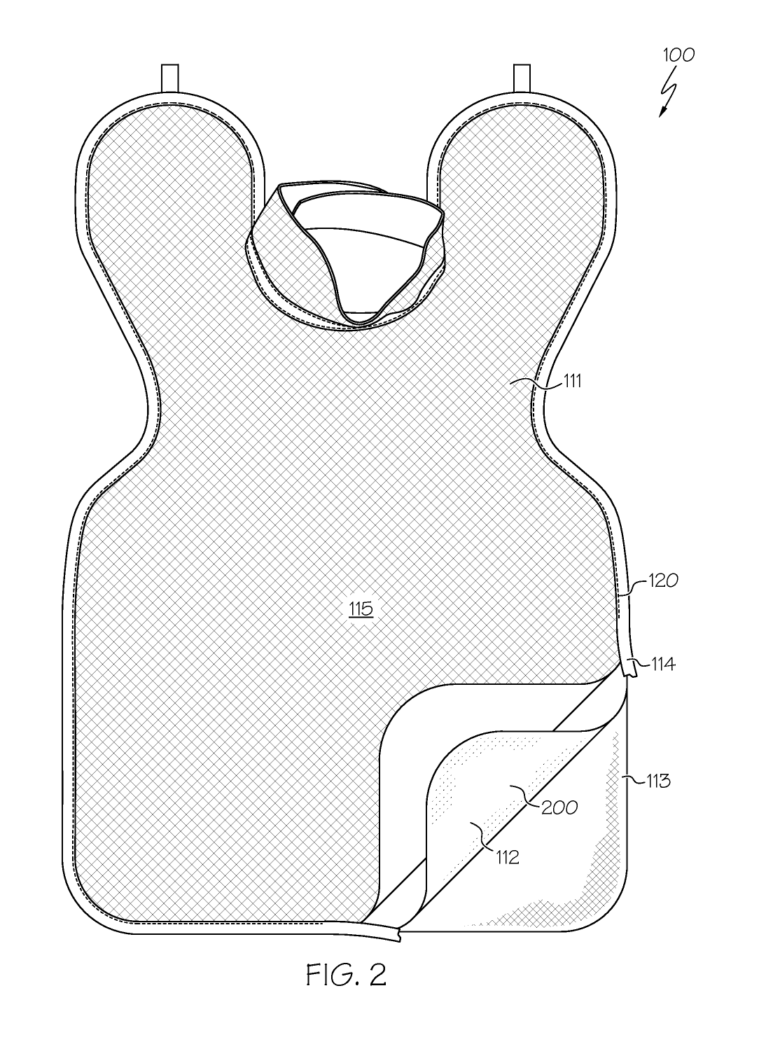

FIG. 2 is a simplified plan view, partially opened at one corner, of the first side of the garment 100. A portion of the middle layer 112 is shown in FIG. 2. The middle layer 112 is an x-ray blocking, or radioprotective, layer. The middle layer 112 includes a radioprotective core material 200. The radioprotective core material 200 is a pliable, rubber-like material in which a radiation blocking metal or material is incorporated. Therefore, the radioprotective core material 200 of the middle layer 112 at least partially shields the wearer of the garment 100 from radiation. In one embodiment, the radioprotective core material 200 comprises a polymeric flexible sheet that is made of one of one or more of the materials selected from the group consisting of: thermoplastic or thermosetting polymer, thermoplastic polyamide, vinyl polymer and polyethylene generally available from E.I. DuPont de Nemours and Company of Wilmington, Del. The polymeric flexible sheet includes a radiation attenuating material such as barium, bismuth, tin, antimony, tungsten, zirconium or lead as salts or oxides. Advantageously, the middle layer 112 is more flexible than known radioprotective layers of known radiation protective garments. Creases, tears and holes do not occur in the radioprotective core material 200 of the middle layer 112 during machine washing. The middle layer 112 can withstand bending and movement of machine washing. A range of flexibility of the middle layer 112 according to American Society for Testing and Materials (ASTM) standard D747 is 4 to 18 pounds per square inch (psi) in both a machined direction, or length, and a cross direction, or width.

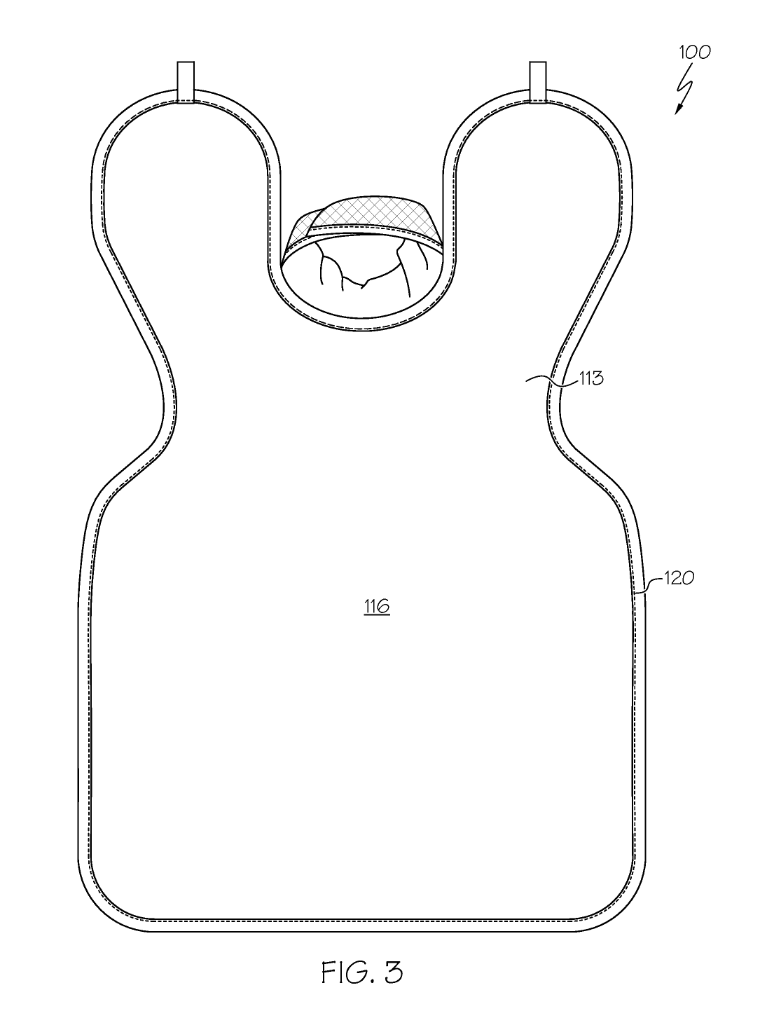

FIG. 3 is a simplified plan view of a second side, opposite the first side, of the garment 100. The inner layer 113 of the garment 100 is shown in FIG. 3. The inner layer 113 is a layer closest to the wearer when the garment 100 is properly worn. The inner layer 113 comprises high density nylon pack cloth. A nearest side 116 of the inner layer 113 is shown in FIG. 3.

As shown in FIGS. 1, 2 and 3, the three layers of the garment 100 are bound together by a binding cloth 114 that is sewn onto the garment at a perimeter of the garment such that the binding cloth overlaps a farthest side 115 of the outer layer 111 and a nearest side 116 of the inner layer 113. In one embodiment, the three layers of the garment 100 are permanently bound together by the binding cloth 114 such that the radioprotective core material 200 of the middle layer 112 cannot be separated from the inner layer 111 or from the outer layer 113. The binding cloth 114 is sewn onto the garment 100 using a heavy thread 120. A stitching range for the sewing of the binding cloth 114 onto the garment 100 is 8-12 stitches per inch. In one embodiment, the heavy thread 120 is a thread from American & Efird, Inc., of Mount Holly, N.C. The weight of the heavy thread 120 is selected to withstand the strains of machine washing of the garment 100. In one embodiment, the heavy thread 120 is nylon or polyester thread sized in a range from 069 (commercial), 70 (tex size) or E (government size) to 277 (commercial), 270 (tex size) or 4-CORD (government size).

The garment 100 combines several elements that make the garment machine washable. Such elements include: a more flexible radioprotective core material 200, a unique stitching, and a specially-selected thread 120. Advantageously, the garment 100 can be repeatedly machine washed without losing its integrity, effectiveness or usability.

Known radiation protective garments are made using stiffer and/or less flexible radioprotective core material. Known radiation protective garments are made using fewer stitches per inch and with thinner, or lighter weight, thread. Consequently, known radiation protective garments cannot withstand the rigors and violent movements associated with machine washing.

In one embodiment, the garment 100 is a medical apron. In another embodiment, the garment 100 is a dental apron. In still another embodiment, the garment 100 is a thyroid cover. The garment 100 can be used during a medical procedure, during a dental procedure or during a veterinary procedure.

The specification and figures are to be regarded in an illustrative rather than a restrictive sense, and all such modifications are intended to be included within the scope of the present invention. Any benefits, advantages or solutions to problems described herein with regard to specific embodiments are not intended to be construed as a critical, required or essential feature or element of any or all the claims.

Although the invention is described herein with reference to specific embodiments, various modifications and changes can be made without departing from the scope of the present invention as set forth in the claims below.

We claim:

1. A washable radiation protective garment, comprising:
an outer layer including a ripstop fabric;
a middle layer including a flexible radioprotective core material; and
an inner layer including a pack cloth.

2. The washable radiation protective garment of claim 1, wherein flexibility of the middle layer according to ASTM standard D747 is 4 to 18 psi.

3. The washable radiation protective garment of claim 1, including a binding cloth sewn onto the garment at a perimeter of the garment such that the binding cloth overlaps and a back of the outer layer and a front of the inner layer, wherein the three layers of the garment are bound together by the binding cloth.

4. The washable radiation protective garment of claim 3, wherein the binding cloth is sewn onto the garment with a heavy thread sized between 069 and 277 (commercial) and stitched at 8-12 stitches per inch.

5. A dental apron, comprising:
an outer layer including a ripstop fabric;
a middle layer including a pliable radioprotective core material; and
an inner layer including a pack cloth.

6. A thyroid cover, comprising:
an outer layer including a ripstop fabric;
a middle layer including a flexible radioprotective core material; and
an inner layer including a pack cloth.
